(19) United States
(12) Patent Application Publication
(10) Pub. No.: US 2021/0044125 A1
(43) Pub. Date: Feb. 11, 2021

(54) DUAL CORD LOCKOUT MECHANISM

(71) Applicant: Ridge Tool Company, Elyria, OH (US)

(72) Inventors: Billy Odon M. YRAD, JR., Elyria, OH (US); Sheng Cai KUANG, Nanjing (CN)

(21) Appl. No.: 16/944,920

(22) Filed: Jul. 31, 2020

Related U.S. Application Data
(63) Continuation of application No. 29/701,221, filed on Aug. 9, 2019, now Pat. No. D897948.

(51) Int. Cl. H02J 7/00; H01R 27/00; H01R 13/50

(52) U.S. Cl. CPC H02J 7/0045; H01R 13/501; H01R 27/00

(57) ABSTRACT

Electrical chargers for batteries and battery packs are described. The chargers include a recessed region having input ports or connectors for receiving power cords providing electrical power to the charger. The input ports or connectors ensure that only one of two ports or connectors is used for electrical connection to a power cord. Thus, due to the configuration of the input ports or connectors, two ports or connectors can not be used concurrently.

### CROSS REFERENCES TO RELATED APPLICATION(S)

The present application claims priority on U.S. design patent application Ser. No. 29/701,221 filed Aug. 9, 2019 which is hereby incorporated by reference in their entirety.

### FIELD

The present subject matter relates to electrical chargers for batteries and battery packs, and particularly to electrical input ports on such battery chargers.

### BACKGROUND

Battery chargers for power tools and other products use integrated power supplies to convert electrical power from DC or AC sources (commonly referred to as “mains” power lines) to DC outputs. Since various standards exist for connecting AC and DC powered cords to devices, it is common for chargers to use multiple input connectors to accommodate the various power sources available. However, incompatibility of these power sources make it necessary to electrically (e.g., via electronic circuitry) or mechanically (e.g., physically) isolate the sources so that the charger input is mutually exclusive to one or the other.

### SUMMARY

The difficulties and drawbacks associated with previous approaches are addressed in the present subject matter as follows.

In one aspect, the present subject matter provides a dual power cord lockout mechanism comprising a first input power cord having a first connector at an end portion thereof, and a second input power cord having a second connector at an end portion thereof. The mechanism also comprises a battery charger configured to convert input power from AC or DC sources to DC output power. The battery charger includes a base and at least one sidewall angled relative to the base. The at least one sidewall is configured to provide an integral recess defining a planar surface spaced from the sidewall and having at least two end portions. The recess and the planar surface extend into the battery charger. The battery charger also includes a first inclined surface having at least two end portions, a first end portion of said first inclined surface being integral with the sidewall at a first location, and a second end portion of said first inclined surface being integral with a first end portion of the planar surface. The first end portion of the first inclined surface is spaced from the second end portion of the first inclined surface. The battery charger additionally includes a second inclined surface having at least two end portions, a first end portion of said second inclined surface being integral with the planar surface at a second end portion spaced from the first end portion of the planar surface, and a second end portion of said second inclined surface, opposite the first end portion of the second inclined surface, which is integral with the sidewall at a second location spaced from the first location. One of the first and second inclined surfaces is operatively configured to connect to and mate with one of the first and second connectors, whereby said one of the first and second power cords thus connected provides input power to the battery charger. The other one of the first and second inclined surfaces is operatively configured to connect to and mate with the other one of the first and second connectors, whereby said other one of the first and second power cords thus connected provides input power to the battery charger. The first and second connectors are configured so that only one of the first and second connectors can be connected to an associated one of the first and second inclined surfaces at a time.

In another aspect, the present subject matter provides a battery charger system comprising a battery charger having a housing that includes at least one sidewall defining an exterior surface. The housing defines a recessed region accessible along an exterior of the housing. The battery charger system also comprises a first connection port configured to engage a first input power cord, the first connection port located within the recessed region of the housing. And, the battery charger system comprises a second connection port configured to engage a second input power cord, the second connection port located within the recessed region of the housing. The first connection port and the second connection port are arranged within the recessed region so that only one of the first and second input power cords can be connected to an associated one of the first and second connection ports at a time.

In still another aspect, the present subject matter provides a battery charger system comprising a battery charger having a housing that includes at least one sidewall defining an exterior surface. The housing defines a recessed region accessible along an exterior of the housing. The battery charger system also comprises a first connection port configured to engage a first input power cord. The first connection port is located within the recessed region of the housing. The battery charger system additionally comprises a second connection port configured to engage a second input power cord. The second connection port is located within the recessed region of the housing. The first connection port defines a first connection axis and the second connection port defines a second connection axis. The first and second connection ports are configured such that the first connection axis and the second connection axis extend at a nonparallel angle to one another.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

FIGS. 1 and 3 are perspective views of an embodiment of a battery charger and an input power cord detached from the battery charger in accordance with the present subject matter.

FIGS. 2 and 4 are perspective views of the battery charger and the input power cord from FIGS. 1 and 3 in which the input power cord is engaged with the battery charger.

FIGS. 5 and 7 are perspective views of an embodiment of a battery charger and another input power cord detached from the battery charger in accordance with the present subject matter.

FIGS. 6 and 8 are perspective views of the battery charger and the input power cord from FIGS. 5 and 7 in which the input power cord is engaged with the battery charger.

FIGS. 9 and 10 are top plan views of the battery charger and input power cord from FIGS. 1-4 showing the cord detached from, and engaged with, the battery charger and an angular orientation at which cord engagement occurs.

FIGS. 11 and 12 are top plan views of the battery charger and the other input power cord from FIGS. 5-8 showing the cord detached from, and engaged with, the battery charger and an angular orientation at which cord engagement occurs.

FIG. 13 is a top plan view of the battery charger and input power cord as shown in FIG. 12 and illustrates blocking interference with the input power cord from FIG. 10.

FIG. 14 is a top plan view of the battery charger and input power cord as shown in FIG. 10 and illustrates blocking interference with the input power cord from FIG. 12.

FIG. 15 is a perspective view of the battery charger illustrating a recess or recess region for electrical power inputs.

FIG. 16 is a rear or side elevational view of the battery charger of FIG. 15 further illustrating the recess.

FIG. 17 is another perspective view of the battery charger further illustrating the recess.

FIG. 18 is an underside plan view of the battery charger.

### DETAILED DESCRIPTION OF THE EMBODIMENTS

An 18V RIDGID RC-30 charger, available from Ridgid Tool Company, e.g., is designed to work on either so-called mains power (100-240 VAC) or approximately 12 VDC power input from an automotive plug. The present subject matter provides a mechanical means to ensure that only one of the mains or the automotive plug may be installed or otherwise connected to the charger (i.e., and not both simultaneously). An additional feature is that the present subject matter provides the means to physically isolate the mains input connector of the charger while the automotive plug is installed.

In many embodiments, the charger is equipped with two input connectors located on an exterior region, and typically a rear portion of the unit. These connectors are arranged on two outward faces shaped in an angled or “V” configuration. The result of this configuration is that the center lines or axes of the connectors (and the respective mating cords/plugs) intersect at a location in space outward and near the charger.

As a result, physical interference of the cords is ensured if the user attempts to install both of the cords/plugs at the same time.

In certain embodiments, one or both of the two cords is equipped with a plug connector with an outward protruding surface. The plug is designed so that only one orientation allows for fit in the mating charger connector. Once this cord is installed, the protruding surface is oriented to cover the other input of the charger.

The mutually exclusive use of the input cord is ensured with an intuitive means. Once a cord is installed, it is not possible to install the other. Another feature of the present subject matter relates to the cords, each of which is clearly distinct in appearance and plug configuration. Moreover, the geometry of the charger is such that no moving parts are required to accomplish isolation. Only the use of one cord or the other is required.

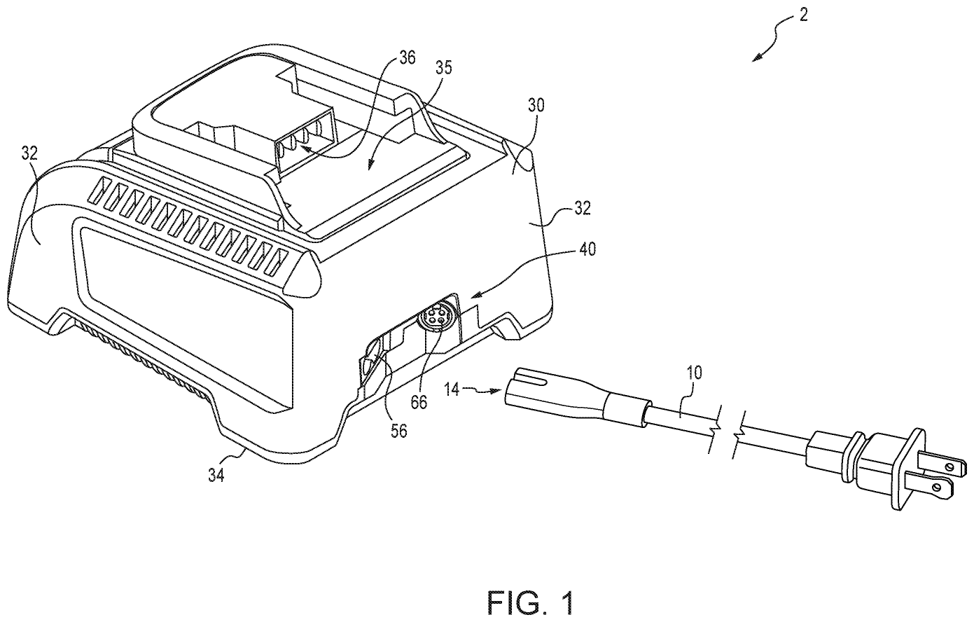

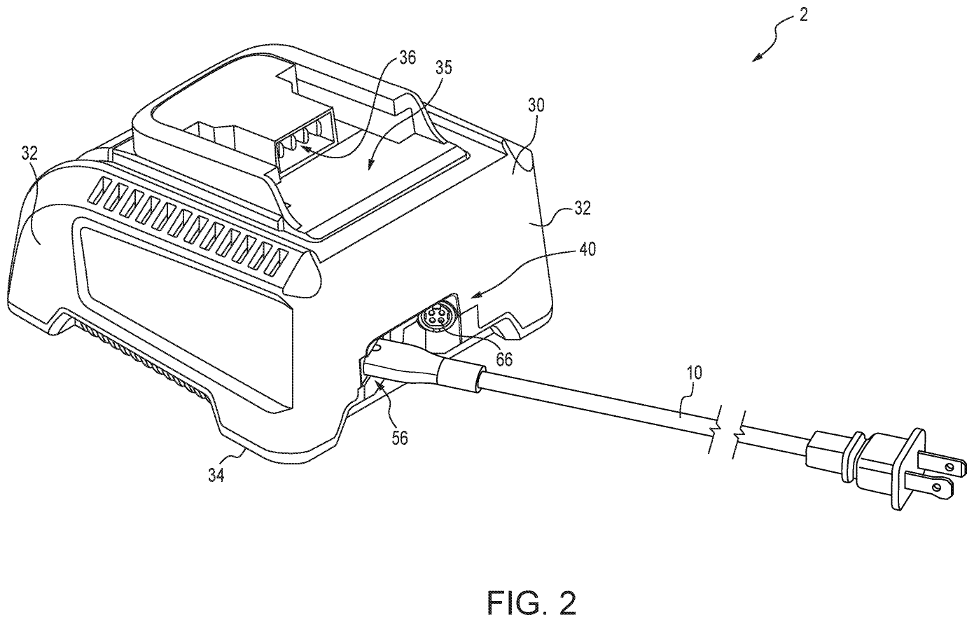

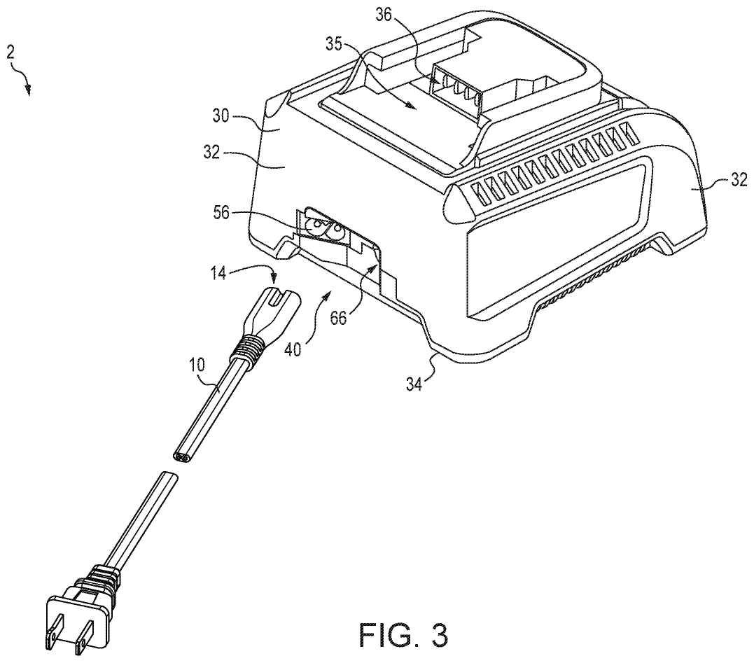

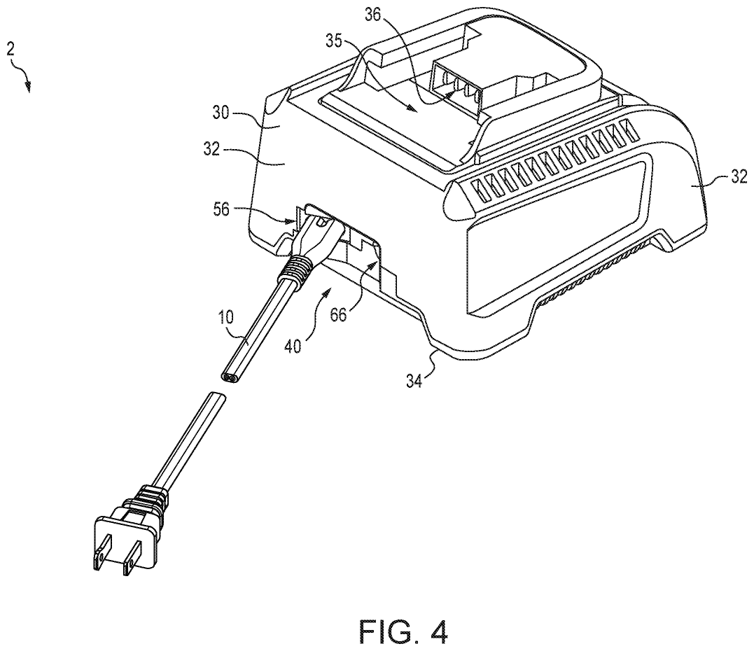

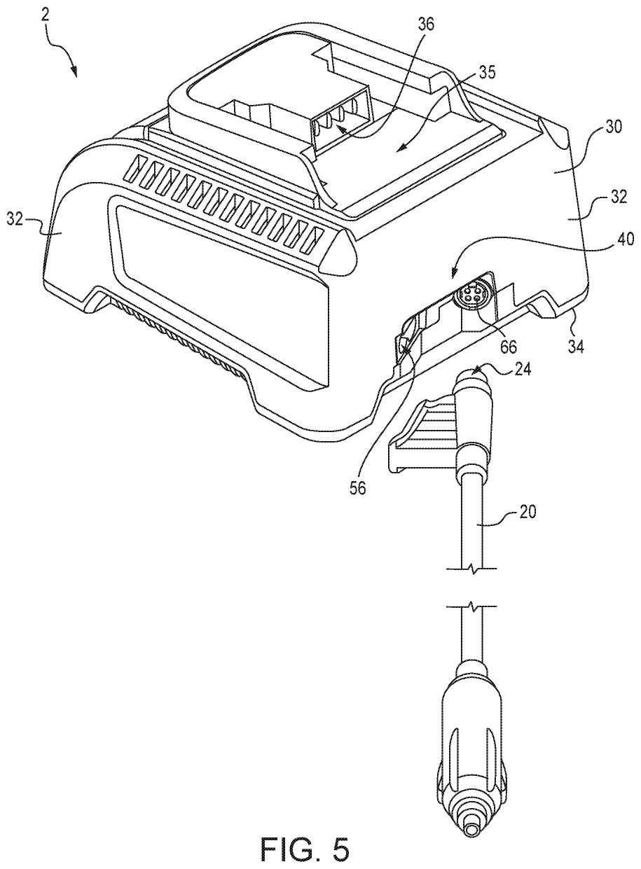

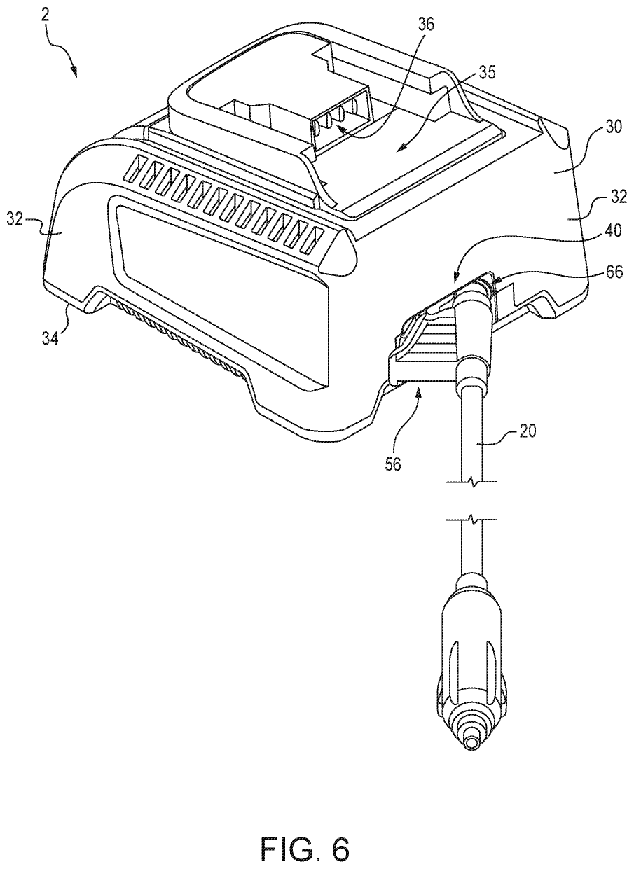

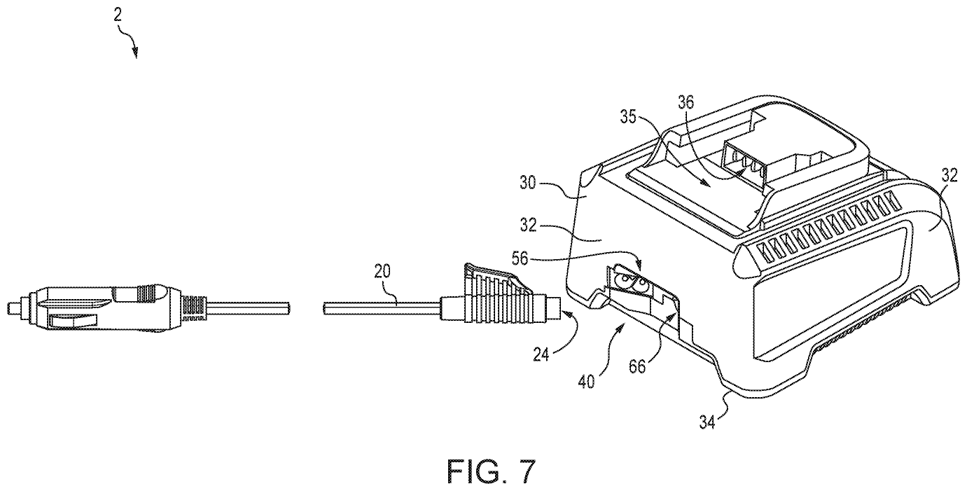

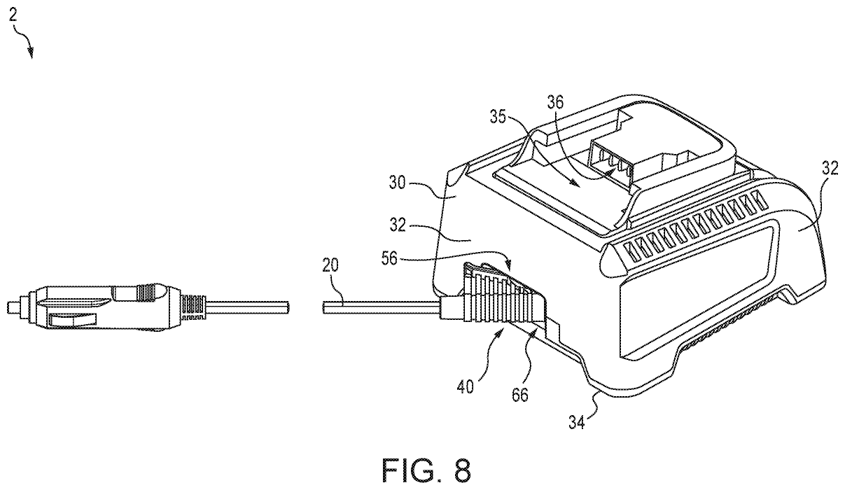

FIGS. 1-4 illustrate a battery charger system 2 comprising a battery charger 30 and a first input power cord 10. FIGS. 5-8 illustrate the battery charger 30 and a second input power cord 20. The battery charger system 2 generally comprises the battery charger 30 and the input power cords 10, 20. It will be understood that the battery charger system 2 may comprise additional components such as other power cords, batteries, battery packs, and related components. In the embodiments described herein, the first input power cord 10 is configured to engage and provide electrical communication with an AC power source, which typically is within a voltage range of from about 100 volts to about 240 volts. It will be understood that the input power cord 10 can be configured to engage a wide array of AC outputs, and/or provide electrical power transfer of AC electrical current at other voltage levels. The input power cord 10 includes a connector 14 for establishing electrical communication with the battery charger 30. Similarly, the second input power cord 20 is configured to engage and provide electrical communication with a DC power source, which typically is within a voltage range of from about 10 volts to about 14 volts, and particularly about 12 volts. It will be understood that the input power cord 20 can be configured to engage a wide array of DC outputs, and/or provide electrical power transfer of DC electrical current at other voltage levels. The input power cord 20 includes a connector 24 for establishing electrical communication with the battery charger 30.

Referring further to FIGS. 1-8, the battery charger 30 includes one or more sidewalls 32 that extend between a base 34 and a docking region 35. The sidewall(s) 32 constitute a charger housing that defines an exterior surface. Typically, the docking region 35 is located along a top or upward facing region of the battery charger 30. However, it will be understood that the present subject matter is not limited to such a configuration and instead includes battery chargers having other locations and configurations of the docketing region. The docketing region 35 is adapted for receiving, engaging, and/or contacting a battery (not shown) to be charged by electrically connecting to an output power connector 36. It will be understood that the docking region 35 and/or the output power connector 36 of the battery charger 30 can take a wide array of different configurations, locations, and arrangements.

The battery charger 30 further comprises a recess or recessed region 40 for electrical power inputs. Disposed within the recess 40 are a first connection port 56 and a second connection port 66. The first connection port 56 is configured to engage and provide electrical power transfer from the first input power cord 10 and particularly from the first connector 14. The second connection port 66 is configured to engage and provide electrical power transfer from the second input power cord 20 and particularly from the second connector 24. In accordance with the present subject matter, the first and second connection ports 56, 66 are configured, located, and/or arranged such that only one of the input power cords 10, 20 can be engaged with an associated connection port 56, 66. Thus, if the first input power cord 10 is engaged with the first connection port 56, then the second input power cord 20 can not be engaged with the second connection port 66. Similarly, if the second input power cord 20 is engaged with the second connection port 66, then the first input power cord 10 can not be engaged with the first connection port 56.

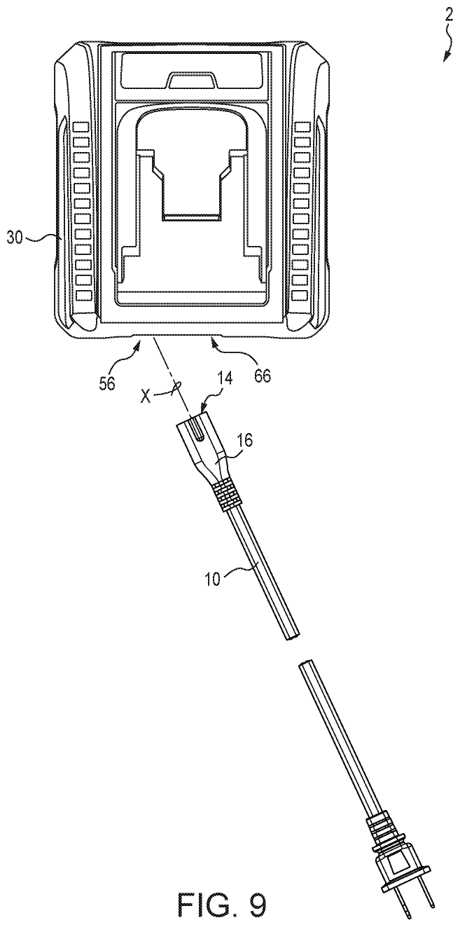

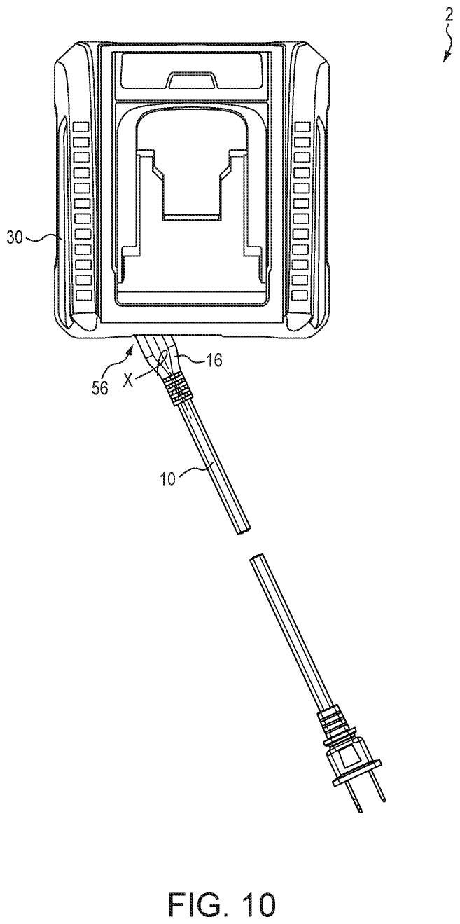

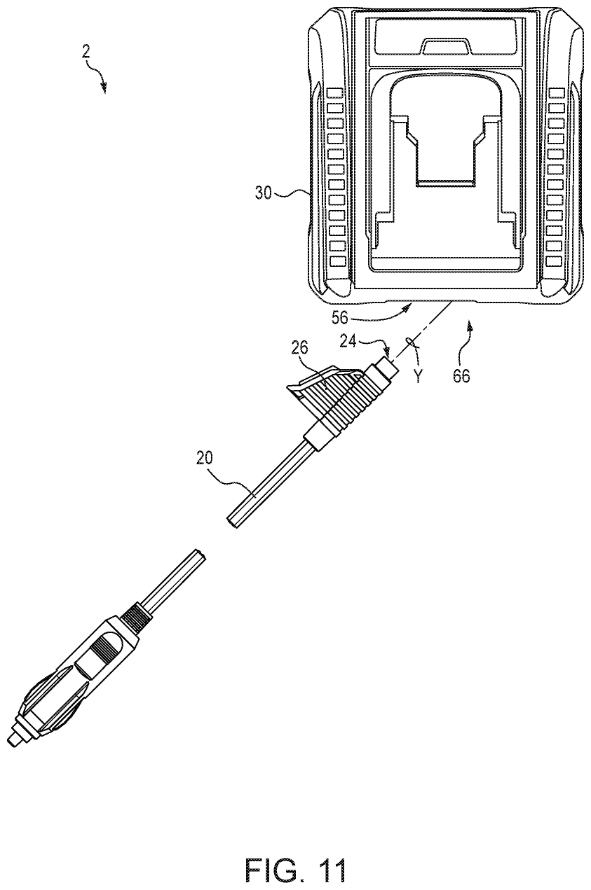

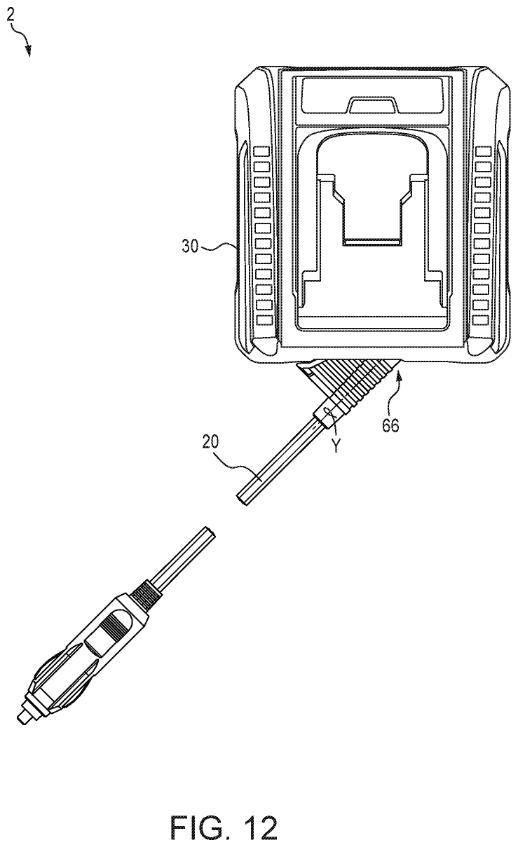

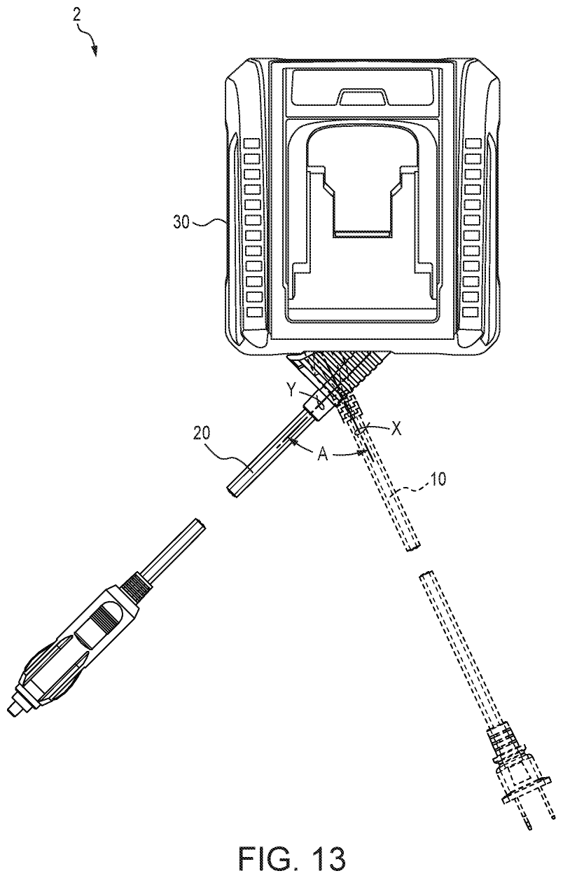

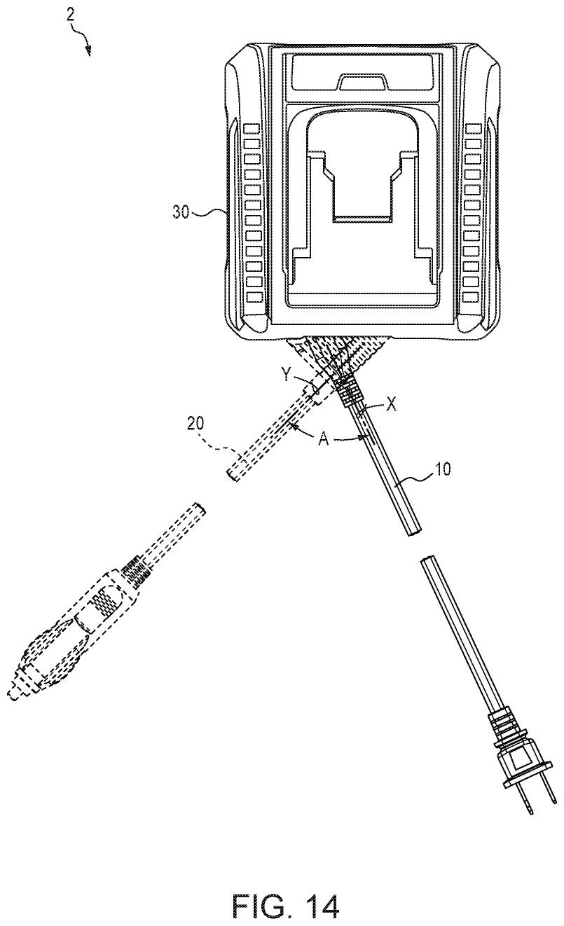

In many embodiments, the first and second connection ports 56, 66 are oriented at a nonparallel angle relative to each other such that engagement of one input power cord 10, 20 with an associated connection port 56, 66, precludes engagement of the other input power cord with its corresponding connection port 56, 66. This configuration of the first and second connection ports 56, 66 can be expressed by reference to a first connection axis X of the first connection port 56 and a second connection axis Y of the second connection port 66. The connection axes X and Y are illustrated in FIGS. 9-12. In many embodiments, the first connection axis X and the second connection axis Y extend at an angle A relative to one another. FIGS. 13 and 14 illustrate angle A. Typically, angle A is within a range of from 20° to 160°, and particularly from 30° to 120°. In certain versions, angle A is within a range of from 75° to 105°. However, it will be understood that the present subject matter includes other angular ranges and is not limited to these representative ranges.

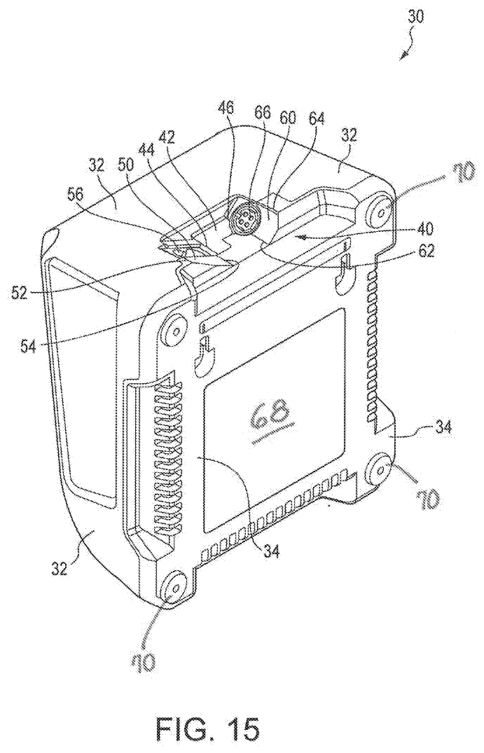

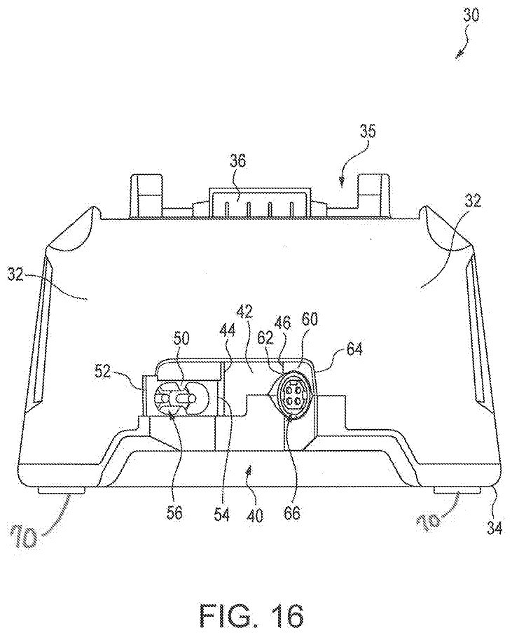

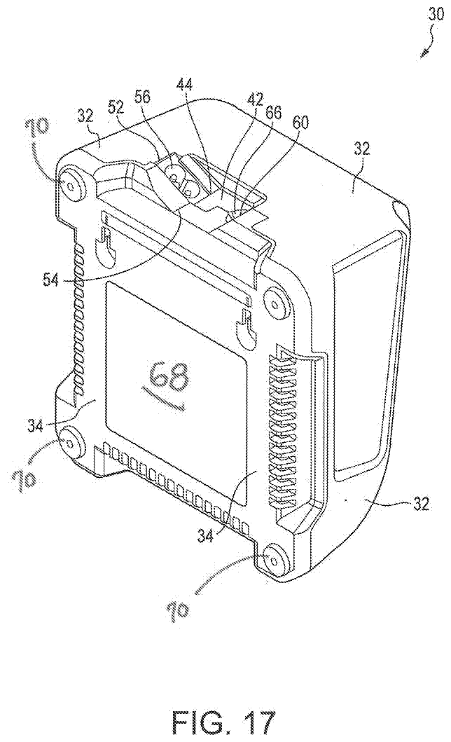

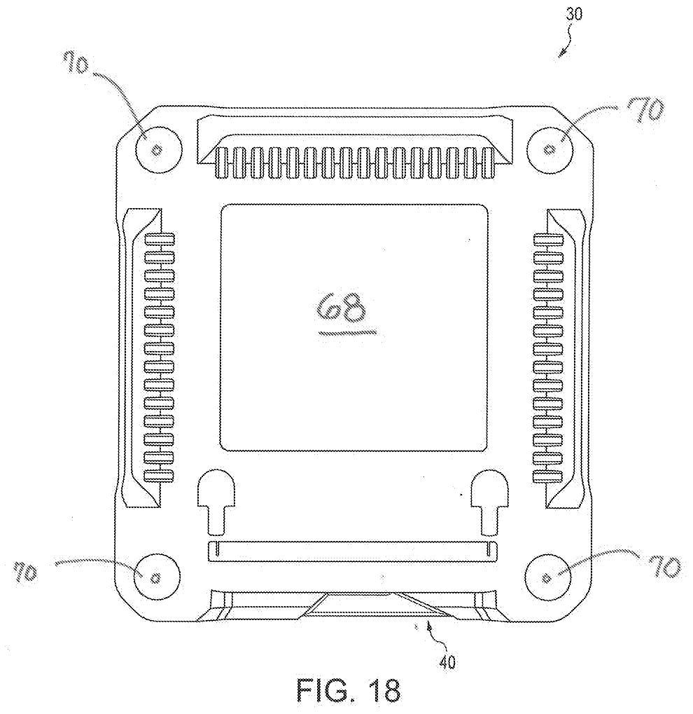

Certain embodiments of the present subject matter utilize a particular configuration of the first and second connection ports 56, 66 disposed within the recess 40 of the battery charger 30. Referring to FIGS. 15-17, a recessed planar surface 42 generally separates and extends between a first inclined surface 50 and a second inclined surface 60. The planar surface 42 defines a first end portion 44 and a second end portion 46. The first inclined surface 50 defines a first end portion 52 and a second end portion 54. The second inclined surface 60 defines a first end portion 62 and a second end portion 64. In many versions, the first end portion 52 of the first inclined surface 50 is integral or continuous with the sidewall 32 of the battery charger 30. And the second end portion 54 of the first inclined surface 50 is integral or continuous with the first end portion 44 of the planar surface 42. Similarly, in many versions, the first end portion 62 of the second inclined surface 60 is integral or continuous with the second end portion 46 of the planar surface 42. And, the second end portion 64 of the second inclined surface 60 is integral or continuous with the sidewall 32 of the battery charger 30. As depicted in FIG. 18, in many versions, the first and second connection ports 56, 66 are entirely recessed within the recessed region 40 and are not visible from a top or bottom plan view. The charger 30 includes an underside surface 68 (see, e.g., FIG. 15) that is integral with the base 34. To space the underside surface 68 of the charger 30 above a surface on which the charger 30 is placed, the charger includes mounting pads 70 (FIGS. 15-18) fixed to the corner portions of the base 34.

In certain embodiments, one or both of the input power cords 10, 20 include provisions and/or features as follows. Referring to FIGS. 9-12, the first input power cord 10 further includes an enlarged portion 16 proximate the first connector 14. The enlarged portion 16 is sized and shaped such that upon engaging the first connector 14 with the first connection port 56, access to the second connection port 66 by the second input power cord 20 is precluded. Similarly, the second input power cord 20 further includes an enlarged portion 26 proximate the second connector 24. The enlarged portion 26 of the second input power cord 20 is sized and shaped such that upon engaging the second connector 24 with the second connection port 66, access to the first connection port 56 by the first input power cord 10 is precluded. The present subject matter includes both power cords 10, 20 including the enlarged portions, or only one power cord having the enlarged portion.

The battery charger such as charger 30 can be provided in a wide array of different forms, configurations, sizes, capacities, and/or arrangements. Generally, the battery charger includes provisions to convert input AC power at one of the connection ports, such as the first connection port 56 and/or the second connection port 66 for example, to DC output power. The battery charger can also include provisions to convert input DC power at one of the connection ports, such as the first connection port 56 and/or the second connection port 66 for example, to DC output power. Typically, the voltage of the DC output power is different than the voltage of the input DC power. The DC output power provided by the battery charger 30 is typically available proximate and/or within the docking region 35 and particularly at the output power connector 36. As will be understood, upon engagement with a battery or battery pack, DC output power is provided from the battery charger 30 to the battery or battery pack via the output power connector 36.

The battery chargers described herein can be used in association with a wide array of power tools and batteries associated with such tools. Nonlimiting examples of power tools include those using permanent magnet DC brushed motors, universal motors, and permanent magnet brushless DC motors, and may include constant speed and variable speed tools. The tools may include cordless power tools such as drills, circular saws, screwdrivers, reciprocating saws, oscillating tools, impact drivers, and flashlights, among others. Further examples of power tools include chainsaws, string trimmers, hedge trimmers, lawn mowers, nailers, and/or rotary hammers. Additional examples of power tools may also or alternatively include miter saws, hammer drills, grinders, and compressors. It will be understood that these are merely examples of tools and applications of the present subject matter, and in no way is the present subject matter limited to any of these examples.

Many other benefits will no doubt become apparent from future application and development of this technology.

All patents, applications, standards, and articles noted herein are hereby incorporated by reference in their entirety.

The present subject matter includes all operable combinations of features and aspects described herein. Thus, for example if one feature is described in association with an embodiment and another feature is described in association with another embodiment, it will be understood that the present subject matter includes embodiments having a combination of these features.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

What is claimed is:

1. A battery charger system comprising:
a battery charger having a housing including at least one sidewall defining an exterior surface, the housing defining a recessed region accessible along an exterior of the housing;
a first connection port configured to engage a first input power cord, the first connection port located within the recessed region of the housing;
a second connection port configured to engage a second input power cord, the second connection port located within the recessed region of the housing;
wherein the first connection port and the second connection port are arranged within the recessed region so that only one of the first and second input power cords can be connected to an associated one of the first and second connection ports at a time.

2. The battery charger system of claim 1, wherein the first connection port defines a first connection axis and the second connection port defines a second connection axis, the first connection axis and the second connection axis extending nonparallel to one another.

3. The battery charger system of claim 2, wherein the first connection axis and the second connection axis extend at an angle relative to one another within a range of from 20° to 160°.

4. The battery charger system of claim 3, wherein the angle is within a range of from 30° to 120°.

5. The battery charger system of claim 1, further comprising:
a first input power cord including a first connector at an end portion thereof, the first connector adapted to engage and provide electrical connection to the first connection port.

6. The battery charger system of claim 5, further comprising:
a second input power cord having a second connector at an end portion thereof, the second connector adapted to engage and provide electrical connection to the second connection port.

7. The battery charger system of claim 1, further comprising:
provisions to convert input AC power at one of the first connection port and the second connection port to DC output power.

8. The battery charger system of claim 7, further comprising:
provisions to convert input DC power at one of the first connection port and the second connection port to DC output power.

9. The battery charger system of claim 1, wherein the first input power cord further includes an enlarged portion proximate the first connector, the enlarged portion sized and shaped such that upon engaging the first connector with the first connection port, access to the second connection port by the second input power cord is precluded.

10. The battery charger system of claim 9, wherein the second input power cord further includes an enlarged portion proximate the second connector, the enlarged portion of the second input power cord sized and shaped such that upon engaging the second connector with the second connection port, access to the first connection port by the first input power cord is precluded.

11. The battery charger system of claim 1 wherein the battery charger includes a base defining an underside surface, wherein the base further defines a plurality of corner portions, and wherein each corner portion has affixed thereto a mounting pad, for spacing the battery charger above a surface upon which the battery charger is placed.

12. A battery charger system comprising:
a battery charger having a housing including at least one sidewall defining an exterior surface, the housing defining a recessed region accessible along an exterior of the housing;
a first connection port configured to engage a first input power cord, the first connection port located within the recessed region of the housing;
a second connection port configured to engage a second input power cord, the second connection port located within the recessed region of the housing;
wherein the first connection port defines a first connection axis and the second connection port defines a second connection axis, the first and second connection ports configured such that the first connection axis and the second connection axis extend at a nonparallel angle to one another.

13. The battery charger system of claim 12, wherein the first connection axis and the second connection axis extend at an angle relative to one another within a range of from 20° to 160°.

14. The battery charger system of claim 12, further comprising:
a first input power cord including a first connector at an end portion thereof, the first connector adapted to engage and provide electrical connection to the first connection port;
wherein the first input power cord further includes an enlarged portion proximate the first connector, the enlarged portion sized and shaped such that upon engaging the first connector with the first connection port, access to the second connection port by the second input power cord is precluded.

15. The battery charger system of claim 14, further comprising:
a second input power cord having a second connector at an end portion thereof, the second connector adapted to engage and provide electrical connection to the second connection port;
wherein the second input power cord further includes an enlarged portion proximate the second connector, the enlarged portion of the second input power cord sized and shaped such that upon engaging the second connector with the second connection port, access to the first connection port by the first input power cord is precluded.

16. The battery charger system of claim 12, wherein the battery charger includes a base defining an underside surface, wherein the base further defines a plurality of corner portions, and wherein each corner portion has affixed thereto a mounting pad, for spacing the battery charger above a surface upon which the battery charger is placed.
